(19) United States
(12) Patent Application Publication
(10) Pub. No.: US 2016/0335571 A1
(43) Pub. Date: Nov. 17, 2016

(54) WORK SUPPORT METHOD AND WORK SUPPORT SYSTEM

(71) Applicant: FUJITSU LIMITED, Kawasaki-shi (JP)

(72) Inventor: Keita WATANABE, Kawasaki (JP)

(73) Assignee: FUJITSU LIMITED, Kawasaki-shi (JP)

(21) Appl. No.: 15/132,656

(22) Filed: Apr. 19, 2016

(30) Foreign Application Priority Data
May 14, 2015 (JP) 2015-099263

(51) Int. Cl. G06Q 10/06

(52) U.S. Cl. CPC G06Q 10/0633; G06Q 10/06313

(57) ABSTRACT

A work support method executed by a work support system, the work support system including a terminal device, a managing device configured to manage the terminal device, and an information processing device including a camera, the work support method includes receiving, by the terminal device, work information indicating a content of work executed; generating identifying information based on the work information; displaying an image of the generated identifying information; capturing, by the information processing device, the image of the identifying information by the camera; and transmitting the captured image of the identifying information to the managing device; obtaining, by the managing device, the work information from the captured image of the identifying information; determining whether the obtained work information matches with work scenario information indicating a content of work executed by the terminal device; and outputting a result of the determining.

### CROSS-REFERENCE TO RELATED APPLICATION

This application is based upon and claims the benefit of priority of the prior Japanese Patent Application No. 2015-099263, filed on May 14, 2015, the entire contents of which are incorporated herein by reference.

### FIELD

The embodiments disclosed herein are related to a work support method and a work support system.

### BACKGROUND

In conventional setting work or maintenance work for a network apparatus, a worker for example visits a site where the network apparatus is installed, couples the network apparatus with a terminal device for setting, and then issues a command on the basis of a work scenario registered in a management server.

In the conventional setting work or maintenance work, the command issued to the network apparatus by the terminal device for setting is transmitted as work information to the management server. Japanese Laid-open Patent Publication No. 2003-264497 and Japanese Laid-open Patent Publication No. 2014-85683, for example, are disclosed as related art.

In the conventional setting work or maintenance work, when the work information is transmitted from the terminal device for setting to the management server, the network security of the work site is changed so that the terminal device and the management server are coupled to each other. This work is undesirable from a viewpoint of security protection. It is desirable to be able to support work at a remote place without affecting the network security of the work site.

### SUMMARY

According to an aspect of the embodiment, a work support method executed by a work support system, the work support system including a terminal device, a managing device configured to manage the terminal device, and an information processing device including an imaging device, the work support method includes receiving, by the terminal device, work information indicating a content of work executed; generating identifying information based on the work information; displaying an image of the generated identifying information; capturing, by the information processing device, the image of the identifying information by a camera; and transmitting the captured image of the identifying information to the managing device; obtaining, by the managing device, the work information from the captured image of the identifying information; determining whether the obtained work information matches with work scenario information indicating a content of work executed by the terminal device; and outputting a result of the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration of a work support system;

FIG. 2 is a diagram illustrating an example of a hardware configuration of a management server;

FIG. 3 is a diagram illustrating an example of a work scenario database;

FIG. 4 is a diagram of assistance in explaining functions of each device of the work support system according to a first embodiment;

FIG. 5 is a sequence diagram of assistance in explaining an operation of the work support system according to the first embodiment;

FIG. 6 is a flowchart of assistance in explaining processing of an imaging terminal;

FIG. 7A and FIG. 7B are diagrams illustrating an example of an work information input screen in a terminal device in the first embodiment;

FIG. 8 is a diagram of assistance in explaining functions of each device of a work support system according to a second embodiment;

FIG. 9 is a diagram illustrating an example of a character type conversion table;

FIG. 10 is a sequence diagram of assistance in explaining an operation of the work support system according to the second embodiment;

FIG. 11 is a flowchart of assistance in explaining an operation of a terminal device in the second embodiment;

FIG. 12 is a flowchart of assistance in explaining an operation of a management server in the second embodiment; and

FIG. 13A, FIG. 13B, and FIG. 13C are diagrams illustrating an example of a work information input screen in the terminal device in the second embodiment.

### DESCRIPTION OF EMBODIMENTS

### First Embodiment

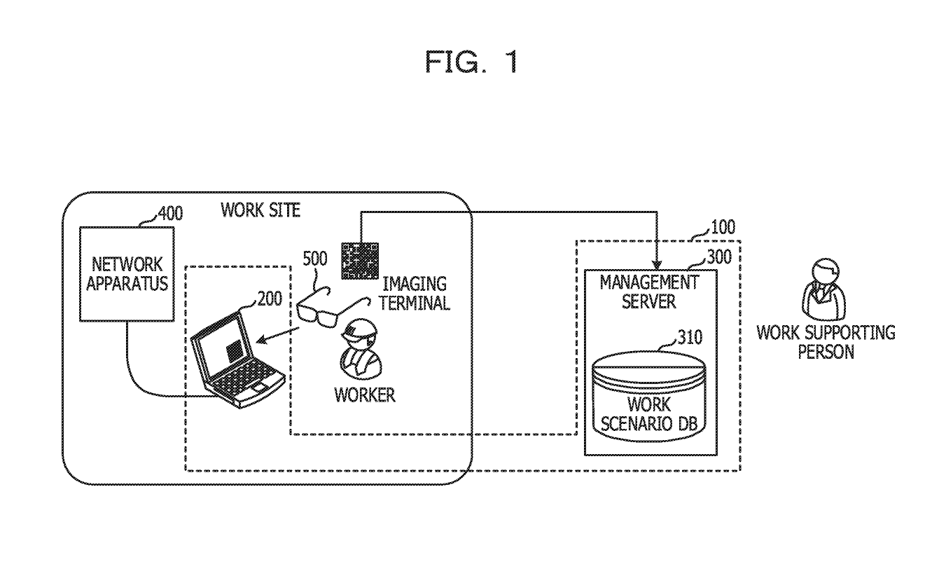

An embodiment will be described in the following with reference to the drawings. FIG. 1 is a diagram illustrating an example of a system configuration of a work support system.

A work support system 100 includes a terminal device 200 and a management server 300. The terminal device 200 in the present embodiment is coupled to a network apparatus 400. The management server 300 in the present embodiment is an ordinary information processing device, and includes a work scenario database 310. The work scenario database 310 in the present embodiment stores work scenario information indicating contents of work using the terminal device 200. Details of the work scenario information will be described later.

The terminal device 200 in the present embodiment is a terminal used for work by a worker on a work site where the network apparatus 400 is disposed. The terminal device 200 sets, in the network apparatus 400, various kinds of information input by the worker according to the work scenario information. In the following description, information input to the terminal device 200 by the worker will be referred to as work information. That is, the work information is information indicating the content of work performed by the worker on the terminal device 200.

The terminal device 200 in the present embodiment converts the input work information into a bar code, and displays the bar code. The displayed bar code is imaged by an imaging terminal 500. The imaging terminal 500 is a terminal device including an imaging device (imaging function). In the present embodiment, the worker may image the bar code by the imaging terminal 500, or a person other than the worker may image the bar code by the imaging terminal 500. The imaging terminal 500 transmits an image of the imaged bar code to the management server 300.

The management server 300 reads the work information input on the terminal device 200 from the image of the bar code which image is received from the imaging terminal 500. The management server 300 then determines whether or not the work information coincides with the work content specified in the work scenario information.

That is, in the present embodiment, the work information input on the terminal device 200 is transmitted to the management server 300 via the imaging terminal 500. Hence, according to the present embodiment, the work information input on the terminal device 200 can be transmitted to the management server 300 even when the terminal device 200 and the management server 300 are not coupled to each other.

Therefore, according to the present embodiment, a network for distributing the work information and a network on the work site can be separated from each other. Then, the network security of each device on the work site can be maintained as it is in an existing state. In other words, according to the present embodiment, the network security of the work site does not need to be changed, and the work at a remote place can be supported without the network security of the work site being affected.

In the above description, the imaging terminal 500 transmits only the image of the bar code to the management server 300, but is not limited to this. The imaging terminal 500 may distribute not only the image of the bar code but also a moving image obtained by photographing a state of work by the worker to the management server 300. In the present embodiment, the distribution of the moving image of the work state can provide the work information to a work supporting person monitoring the work state by the management server 300 in real time.

In the present embodiment, the bar code generated by the terminal device 200 may be a one-dimensional bar code or may be a two-dimensional code. The two-dimensional code is for example a quick response (QR) code or the like.

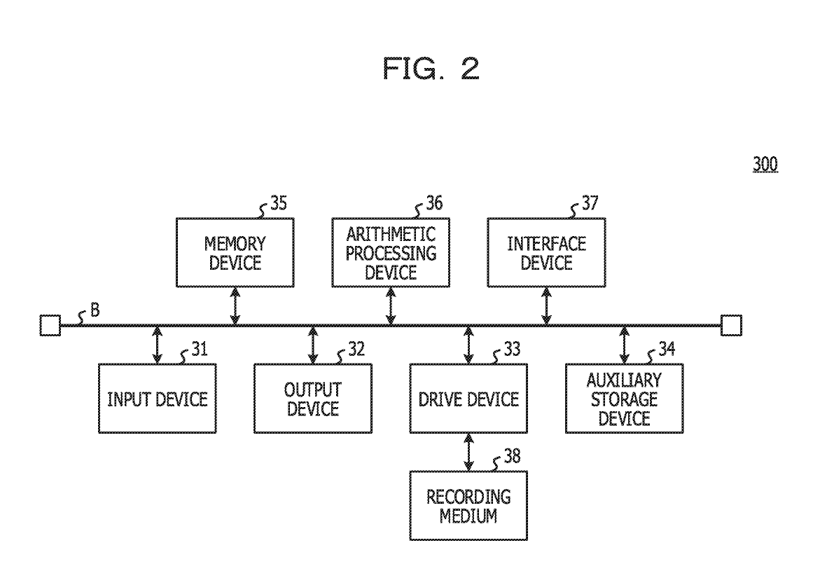

Hardware configurations of the terminal device 200 and the management server 300 in the present embodiment will be described in the following with reference to FIG. 2.

FIG. 2 is a diagram illustrating an example of a hardware configuration of the management server. The management server 300 in the present embodiment includes an input device 31, an output device 32, a drive device 33, an auxiliary storage device 34, a memory device 35, an arithmetic processing device 36, and an interface device 37, which are coupled with each other via a bus B.

The input device 31 includes a keyboard, a mouse, and the like. The input device 31 is used to input various kinds of signals. The output device 32 includes a display device and the like. The output device 32 is used to display various kinds of windows, data, and the like. The interface device 37 includes a modem, a local area network (LAN) card, and the like. The interface device 37 is used to couple to a network.

A work support program is at least a part of various kinds of programs that control the management server 300. The work support program is provided by for example the distribution of a recording medium 38, download from a network, or the like. Usable as the recording medium 38 on which the work support program is recorded are various types of recording media including for example recording media on which information is recorded optically, electrically, or magnetically, such as a compact disc read-only memory (CD-ROM), a flexible disc, a magneto-optical disc, and the like, and semiconductor memories in which information is recorded electrically, such as a ROM, a flash memory, and the like.

When the recording medium 38 on which the work support program is recorded is set in the drive device 33, the work support program is installed from the recording medium 38 into the auxiliary storage device 34 via the drive device 33. The work support program downloaded from the network is installed into the auxiliary storage device 34 via the interface device 37.

The auxiliary storage device 34 stores the installed work support program, and also stores files, data, and the like that may be necessary. The memory device 35 reads the work support program from the auxiliary storage device 34 and stores the work support program when the computer is started. The arithmetic processing device 36 implements various kinds of processing such as will be described later according to the work support program stored in the memory device 35.

The management server 300 in the present embodiment is for example a tablet computer or the like. In that case, a display operating device such as a touch panel having a display function or the like can be provided in place of the input device 31 and the output device 32. The management server 300 in the present embodiment is for example a monitoring terminal including a display device.

The terminal device 200 in the present embodiment is for example an ordinary computer, a tablet computer, or the like. A hardware configuration of the terminal device 200 is similar to that of the management server 300, and therefore description thereof will be omitted.

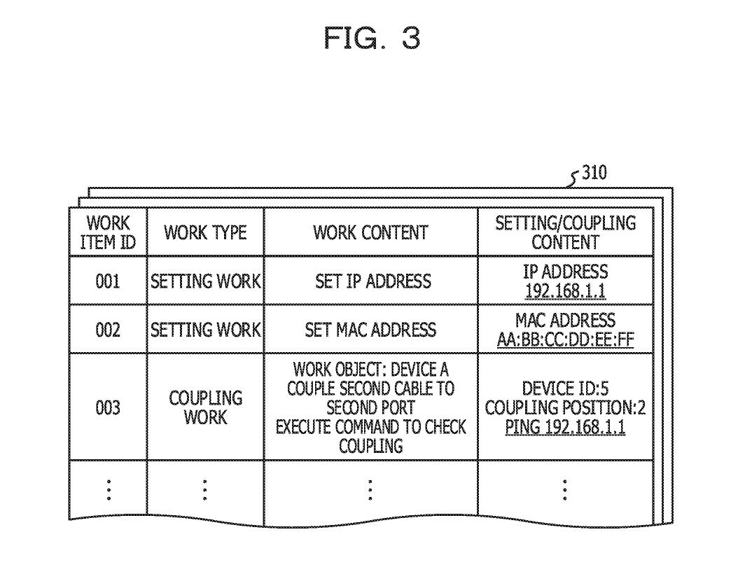

The work scenario database 310 in the present embodiment will next be described with reference to FIG. 3. FIG. 3 is a diagram illustrating an example of the work scenario database.

The work scenario database 310 in the present embodiment includes, as items of information, a work scenario identification (ID), a work item ID, a work type, a work content, and a setting/coupling content.

The value of the item “work scenario ID” is an identifier identifying a work scenario. The value of the item “work item ID” is an identifier identifying a work item included in the work scenario. The value of the item “work type” indicates a kind of work. Kinds of work include for example coupling work of coupling the network apparatus 400 with another apparatus, setting work of setting various kinds of parameters in the network apparatus 400, and the like.

The value of the item “work content” indicates the content of work performed by the worker on the terminal device 200.

The value of the item “setting/coupling content” indicates the content of a coupling to the network apparatus 400 or the content of a setting. In the present embodiment, a numerical part of the value of the item “setting/coupling content” will be referred to as device information, and a part other than the numerical of the value of the item “setting/coupling content” will be referred to as a command. The device information is for example information indicating the value of a parameter set in the network apparatus 400 or the like. The command for example represents an instruction given to the terminal device 200.

In the present embodiment, the value of the item “work scenario” and the value of the item “work item ID” are associated with each other, and further the value of the item “work item ID” is associated with the values of the other items.

In the following description, information including the value of the item “work scenario,” the value of the item “work item ID” associated with the value of the item “work scenario,” and the values of the other items associated with the value of the item “work item ID” will be referred to as work scenario information.

In the present embodiment, a value input to the terminal device 200 by the worker is the value of the item “setting/coupling content.” Hence, in the present embodiment, the value of the item “setting/coupling content” associated with the value of the item “work item ID” is work information.

FIG. 3 illustrates an example of a work scenario ID 01. However, the work scenario database 310 also stores other work scenarios.

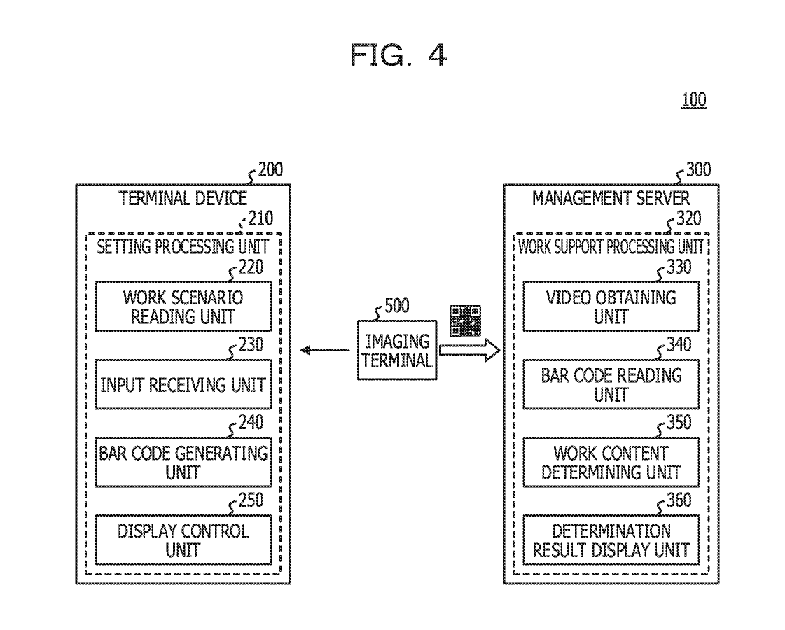

Functions of each device of the work support system 100 according to the present embodiment will next be described with reference to FIG. 4.

FIG. 4 is a diagram of assistance in explaining functions of each device of the work support system according to the first embodiment.

The functions of the terminal device 200 will first be described. The terminal device 200 in the present embodiment includes a setting processing unit 210. The setting processing unit 210 is implemented by an arithmetic processing device of the terminal device 200 by executing a setting program stored in a storage device.

The setting processing unit 210 in the present embodiment includes a work scenario reading unit 220, an input receiving unit 230, a bar code generating unit 240, and a display control unit 250.

The work scenario reading unit 220 in the present embodiment reads work scenario information obtained from the work scenario database 310. The read work scenario information may for example be read when the worker performs work on the work site, and used to display a screen that guides the worker in performing the work.

The work scenario information read by the work scenario reading unit 220 is for example work scenario information read from the management server 300 and stored on a portable storage medium or the like by the worker. In this case, the work scenario reading unit 220 reads the work scenario information from the portable storage medium coupled to the terminal device 200 by the worker, for example.

The work scenario information read by the work scenario reading unit 220 is for example work scenario information read from the management server 300 and stored in the terminal device 200. In this case, the work scenario reading unit 220 reads the work scenario information from the management server 300 coupled to the terminal device 200 before the work, for example.

The input receiving unit 230 receives an input of work information to the terminal device 200. The work information in the present embodiment includes a command and device information.

The bar code generating unit 240 generates a bar code on the basis of the work information input thereto by the input receiving unit 230.

The display control unit 250 displays the generated bar code on an output device (display) of the terminal device 200. The bar code displayed on the terminal device 200 is imaged by the imaging terminal 500, and distributed to the management server 300.

The management server 300 in the present embodiment includes a work support processing unit 320. The work support processing unit 320 in the present embodiment is implemented by the arithmetic processing device 36 of the management server 300 by executing the work support program.

The work support processing unit 320 in the present embodiment includes a video obtaining unit 330, a bar code reading unit 340, a work content determining unit 350, and a determination result display unit 360.

The video obtaining unit 330 in the present embodiment obtains the video of the bar code imaged by the imaging terminal 500 from the imaging terminal 500. The imaging terminal 500 in the present embodiment may transmit the image of the bar code displayed on the terminal device 200 to the management server 300, or may distribute the video of a work state of the worker, the video including the bar code. Hence, the video obtaining unit 330 in the present embodiment may obtain video generated by imaging the bar code and the work state of the worker from the imaging terminal 500. The video obtaining unit 330 may obtain only the image of the bar code. That is, the video obtaining unit 330 in the present embodiment may obtain either of a moving image or a still image.

The bar code reading unit 340 reads the work information input to the terminal device 200 from the bar code included in the obtained moving image or the obtained still image.

The work content determining unit 350 refers to the work scenario database 310, and determines whether or not the work information read by the bar code reading unit 340 coincides with work information stored in the work scenario database 310. That is, the work content determining unit 350 in the present embodiment determines whether or not the work information input on the terminal device 200 is correct.

The determination result display unit 360 displays a result of the determination by the work content determining unit 350 on the display of the management server 300 or the like. The determination result display unit 360 in the present embodiment can transmit the determination result to the imaging terminal 500, and display the determination result on the imaging terminal 500.

The determination result display unit 360 in the present embodiment can display the determination result on another terminal coupled to the management server 300. The terminal coupled to the management server 300 may be used by a work supporting person who supports the work of the worker from a remote place, for example. In this case, the work supporting person can determine whether or not the work content of the worker is correct on the basis of the determination result displayed on the terminal.

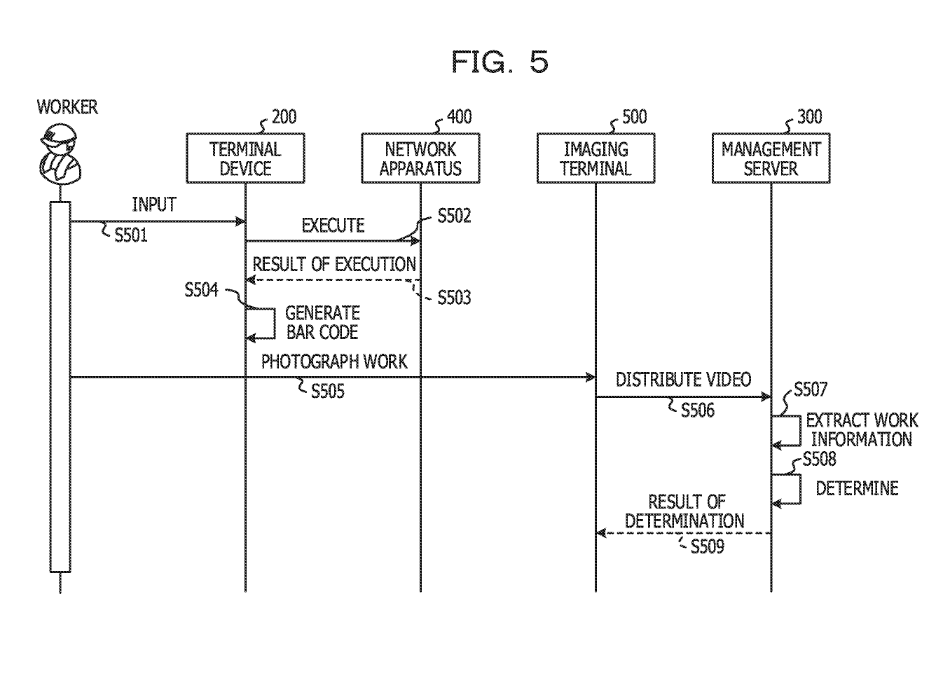

An operation of the work support system 100 in the present embodiment will next be described with reference to FIG. 5. FIG. 5 is a sequence diagram of assistance in explaining an operation of the work support system according to the first embodiment.

In the work support system 100 according to the present embodiment, the terminal device 200 receives an input of work information from the worker by the input receiving unit 230 (S501). Next, the terminal device 200 executes a command included in the work information on the network apparatus 400 (S502), and obtains a result of the execution of the command from the network apparatus 400 (S503).

Next, the terminal device 200 generates a bar code from the input work information by the bar code generating unit 240, and displays the generated bar code by the display control unit 250 (S504). The bar code generating unit 240 in the present embodiment incorporates a work item ID and a work scenario ID corresponding to the work information into the bar code.

Next, the imaging terminal 500 images a work state, for example according to an operation of the worker or the like (S505). The bar code displayed on the terminal device 200 is also included in the imaged video or image. The imaging terminal 500 next distributes the imaged video to the management server 300, for example according to an operation of the worker or the like (S506).

The management server 300 obtains the video distributed by the imaging terminal 500 by the video obtaining unit 330, and extracts the work information from the bar code by the bar code reading unit 340 (S507). At this time, the bar code reading unit 340 also extracts the work item ID and the work scenario ID corresponding to the work information from the bar code.

The management server 300 next determines by the work content determining unit 350 whether or not the work content is correct (S508).

The processing in S508 will be further described in the following. After the work information is extracted, the work content determining unit 350 in the present embodiment refers to the work scenario database 310. Then, the work content determining unit 350 checks the work information corresponding to the work item ID and the work scenario ID extracted from the bar code in the work scenario database 310 against the work information extracted from the bar code, and determines whether or not the work information in the work scenario database 310 and the work information extracted from the bar code coincide with each other.

When the work information in the work scenario database 310 and the work information extracted from the bar code coincide with each other, the work content determining unit 350 determines that the work content is correct. When the work information in the work scenario database 310 and the work information extracted from the bar code do not coincide with each other, on the other hand, the work content determining unit 350 determines that there is an error in the work content.

Next, the management server 300 transmits a result of the determination to the imaging terminal 500 and displays the determination result on the imaging terminal 500 by the determination result display unit 360 (S509).

As described above, in the present embodiment, the determination result is for example transmitted to the imaging terminal 500 and displayed on the imaging terminal 500, so that the worker can determine whether or not there is an error in the work content of the worker himself/herself.

The management server 300 in the present embodiment can for example display the determination result on the display of the management server 300. In this case, the work supporting person can determine whether the work content is correct or incorrect, and can therefore support the work of the worker according to whether the work content is correct or incorrect.

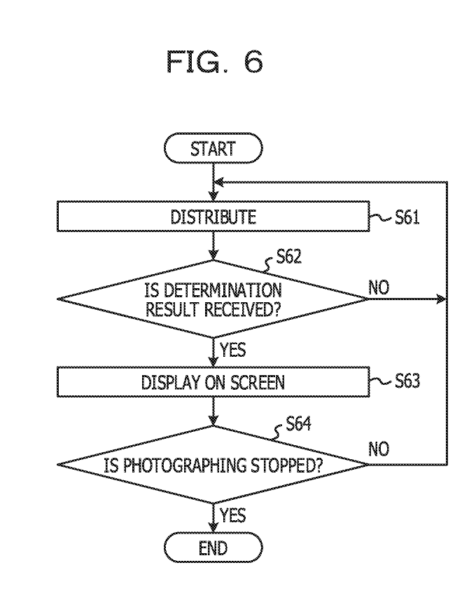

The imaging terminal 500 in the present embodiment will next be described. FIG. 6 is a flowchart of assistance in explaining processing of the imaging terminal.

The imaging terminal 500 in the present embodiment is a computer having an imaging function. A hardware configuration of the imaging terminal 500 is similar to that of the management server 300, and therefore description thereof will be omitted.

After the imaging terminal 500 in the present embodiment distributes video including a bar code (S61), the imaging terminal 500 determines whether or not a determination result is received from the management server 300, the determination result indicating whether a work content is correct or incorrect (S62). When the determination result is not received in S62, the imaging terminal 500 waits.

When the determination result is received in S62, the imaging terminal 500 displays the received determination result on the display (S63). The imaging terminal 500 next determines whether or not photographing is stopped (S64). When the photographing is not stopped in S64, the imaging terminal 500 waits. When the photographing is stopped in S64, the imaging terminal 500 ends the processing.

The imaging terminal 500 in the present embodiment is for example a notebook computer, a smart phone, a tablet terminal, or the like having an imaging function. The imaging terminal 500 in the present embodiment is for example a digital camera, a video camera, or the like.

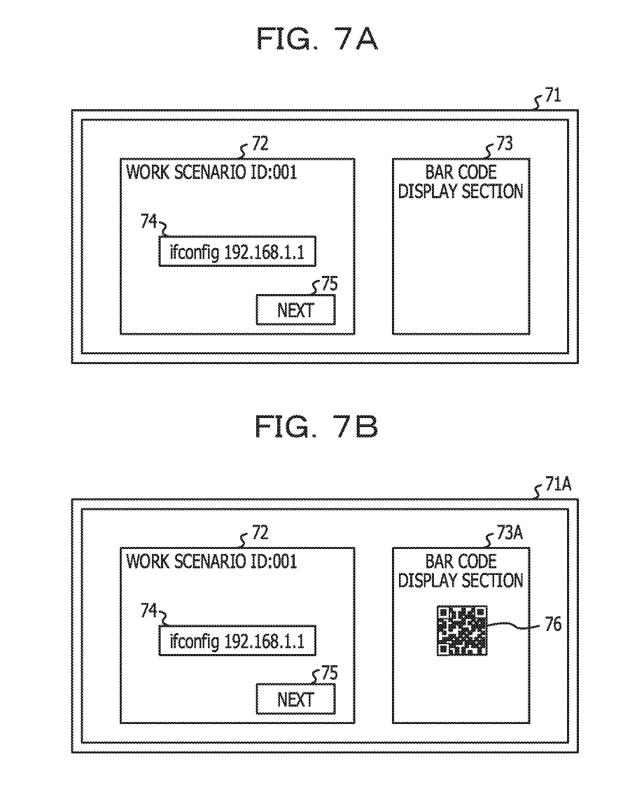

An input of work information on the terminal device 200 will next be described with reference to FIG. 7A and FIG. 7B. FIG. 7A and FIG. 7B are diagrams illustrating an example of a work information input screen in the terminal device in the first embodiment. FIG. 7A illustrates the input screen before display of a bar code. FIG. 7B illustrates the input screen after the bar code is displayed.

A screen 71 illustrated in FIG. 7A is for example displayed when the work scenario reading unit 220 reads work scenario information. In the present embodiment, work items ID included in the work scenario information are numbered consecutively. The terminal device 200 can sequentially display the input screen as represented by the screen 71 in numerical order of the work items ID when reading the work scenario information.

Windows 72 and 73 are displayed on the screen 71. The window 72 displays a work scenario ID, a work information input field 74, and a button 75 for indicating completion of an input. The window 73 is a bar code display section in which a bar code is to be displayed.

In the present embodiment, after completion of an input of work information into the input field 74 on the screen 71, the terminal device 200 generates a bar code based on the input work information. The terminal device 200 then displays the generated bar code in a bar code display section 73A by the display control unit 250. In the present embodiment, it may be determined that the input of the work information is completed when an enter key is depressed following the input of the work information, for example.

A bar code 76 is displayed in the bar code display section 73A illustrated on a screen 71A. In the present embodiment, an image of the bar code 76 can be transmitted to the management server 300 by imaging the bar code display section 73A by the imaging terminal 500.

In the present embodiment, the work information input in the input field 74 is converted into the bar code. The accuracy of recognition of the work information in the management server 300 can therefore be improved.

Consideration will be given to a case where the screen 71 is imaged by the imaging terminal 500, for example. In this case, when a hand of a person performing the imaging moves or an out-of-focus state occurs at the time of the imaging, for example, the work supporting person may not be able to recognize the work information correctly. In the present embodiment, the accuracy of recognition of the work information on the management server 300 side can be improved by converting the work information into the bar code.

When the button 75 is operated on the screen 71A, the terminal device 200 in the present embodiment can change the screen 71A to an input screen of a work item ID given a number following the work item ID corresponding to the screen 71A in the work scenario information.

As described above, according to the present embodiment, work information does not need to be transmitted and received between the terminal device 200 and the management server 300, and the network for distributing the work information and the network on the work site can be separated from each other. Hence, according to the present embodiment, the network security of the work site does not need to be changed, and work at a remote place can be supported without the network security of the work site being affected.

It is assumed that the work support system 100 according to the present embodiment includes the terminal device 200 and the management server 300. However, the work support system 100 according to the present embodiment is not limited to this. The work support system 100 according to the present embodiment may include the imaging terminal 500, for example.

### Second Embodiment

A second embodiment will next be described. The second embodiment is different from the first embodiment in that a case where a work content is changed before work is taken into consideration in the second embodiment. Hence, in the following description of the second embodiment, only differences from the first embodiment will be described. Constituent elements having similar functional configurations to those of the first embodiment are identified by the same reference symbols as the reference symbols used in the description of the first embodiment, and description thereof will be omitted.

First, description will be made of a case where a work content is changed before work. A case where a work content is changed before work in the present embodiment is for example a case where device information related to a setting of a network apparatus 400 or the like is changed after a work scenario reading unit 220 of a terminal device 200A reads work scenario information.

In this case, a work scenario database 310 of a management server 300A stores the work scenario information before the change as it is. Hence, a work content determining unit 350 of the management server 300A in this case may err in determination even when a worker correctly inputs work information according to a new work content after the change, for example. In the present embodiment, even in such a case, the management server 300A can obtain a correct determination result as to whether the work content is correct or incorrect, as will be described in the following.

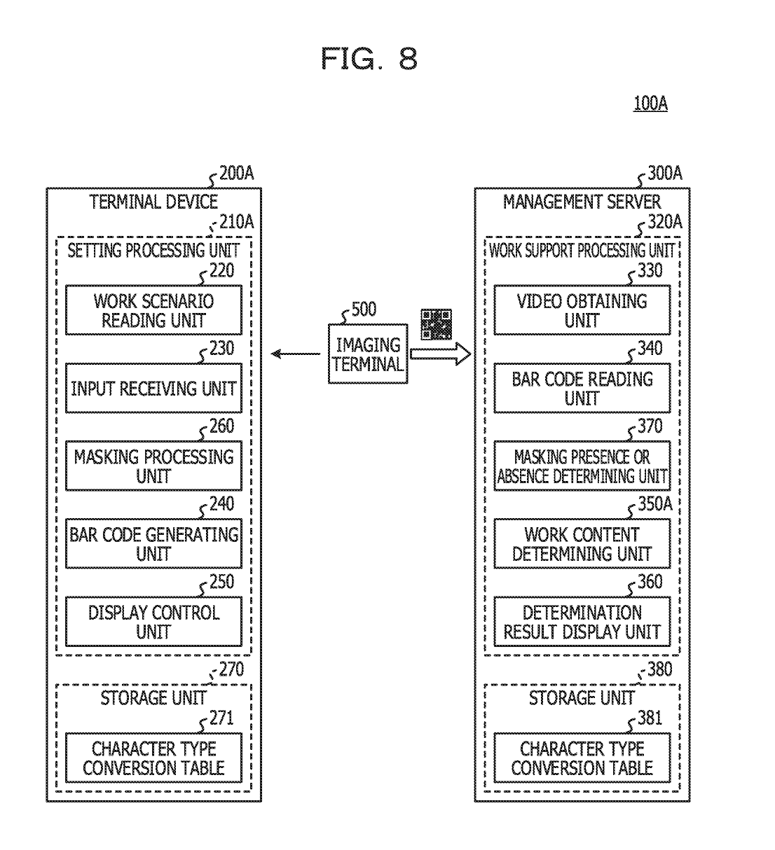

FIG. 8 is a diagram of assistance in explaining functions of each device of a work support system according to the second embodiment. A work support system 100A according to the present embodiment includes a terminal device 200A and a management server 300A.

The terminal device 200A in the present embodiment includes a setting processing unit 210A and a storage unit 270. The setting processing unit 210A includes a masking processing unit 260 in addition to the parts of the setting processing unit 210 in the first embodiment. The storage unit 270 in the present embodiment includes a character type conversion table 271.

When work information is changed, the masking processing unit 260 in the present embodiment refers to the character type conversion table 271, and masks a part changed in the work information. The masking in the present embodiment refers to conversion of the part changed in the work information into a conversion character to be described later. In the present embodiment, the masking processing is performed when the worker notifies the terminal device 200A that the work information is changed. Details of the masking processing unit 260 will be described later.

The management server 300A in the present embodiment includes a work support processing unit 320A and a storage unit 380. The work support processing unit 320A in the present embodiment includes a masking presence or absence determining unit 370 in addition to the parts of the management server 300 in the first embodiment.

The storage unit 380 in the present embodiment includes a character type conversion table 381. The character type conversion table 381 in the present embodiment is a similar table to the character type conversion table 271 of the terminal device 200A.

The masking presence or absence determining unit 370 in the management server 300A in the present embodiment determines whether or not the terminal device 200A has performed masking processing on work information read by a bar code reading unit 340.

When it is determined that the masking processing has been performed, a work content determining unit 350A in the present embodiment determines a work content including the masked part. Details of the work content determining unit 350A in the present embodiment will be described later.

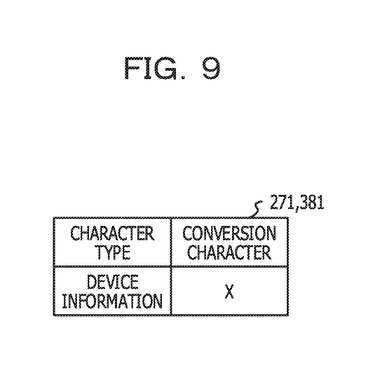

The character type conversion tables 271 and 381 will next be described with reference to FIG. 9. FIG. 9 is a diagram illustrating an example of the character type conversion table.

The character type conversion tables 271 and 381 in the present embodiment are similar to each other. The character type conversion table 271 will therefore be described with reference to FIG. 9.

The character type conversion table 271 in the present embodiment includes a character type and a conversion character as items of information. The value of the item “character type” indicates a type of characters as a conversion object. The value of the item “conversion character” indicates a character into which the conversion object is converted.

The character type conversion table 271 in the present embodiment indicates that the character type indicating device information is converted into a character “X.” The character type indicating the device information is for example a number.

In the example of FIG. 9, the conversion character is “X.” However, the conversion character may be an arbitrary character, or may be a symbol or the like.

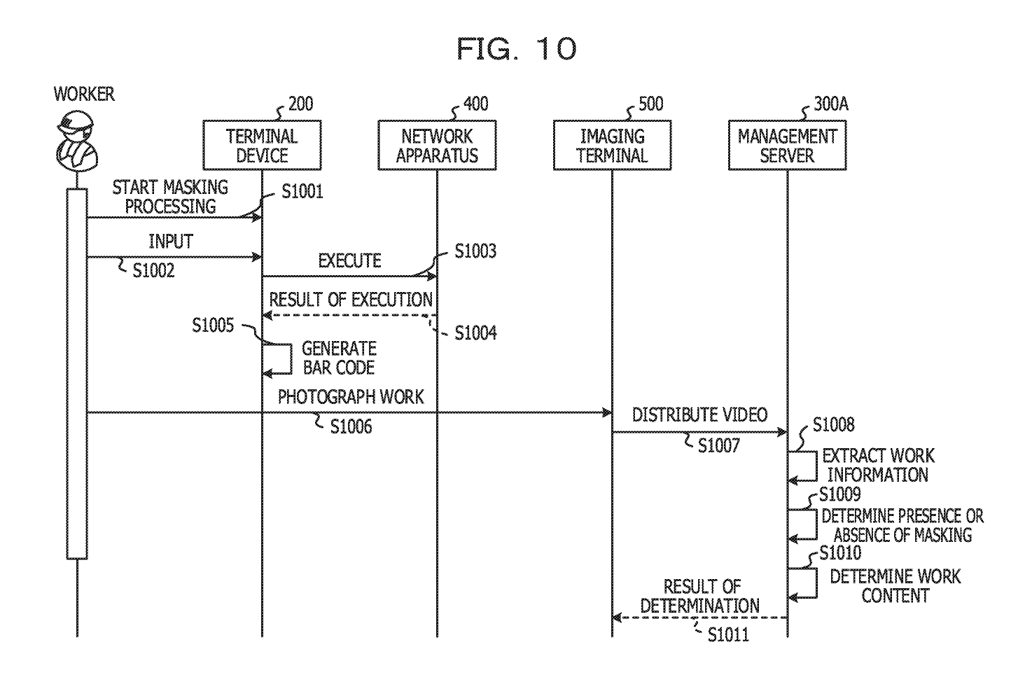

An operation of the work support system 100A according to the present embodiment will next be described with reference to FIG. 10. FIG. 10 is a sequence diagram of assistance in explaining an operation of the work support system according to the second embodiment.

FIG. 10 illustrates an operation of the work support system 100A in a case where the worker notifies the terminal device 200A that work information is changed.

In the work support system 100A according to the present embodiment, the terminal device 200A receives, from the worker, a notification indicating that work information is changed (S1001). In other words, receiving the notification indicating that the work information is changed, the terminal device 200A executes the masking processing unit 260.

The following processing from S1002 to S1008 in FIG. 10 is similar to the processing from S501 to S507 in FIG. 5, and therefore description thereof will be omitted.

After the work information is extracted in S1008, the management server 300A determines by the masking presence or absence determining unit 370 whether or not the work information extracted from a bar code is masked (S1009).

Next, the management server 300A determines by the work content determining unit 350A whether the work content is correct or incorrect according to a result of the determination by the masking presence or absence determining unit 370 (S1010). Details of S1009 and S1010 will be described later.

Subsequent processing in S1011 is similar to the processing in S509 in FIG. 5, and therefore description thereof will be omitted.

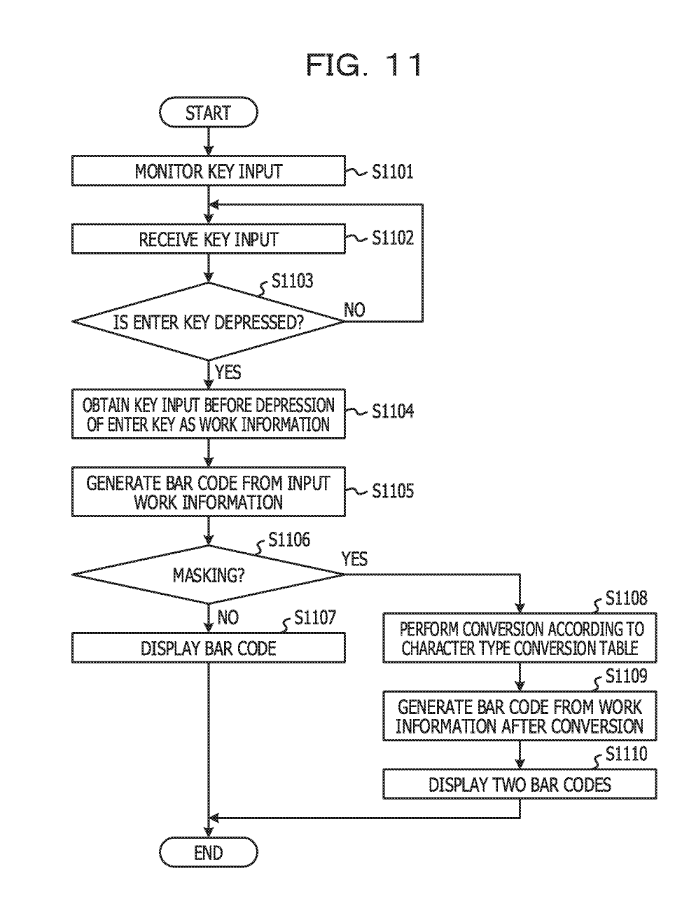

An operation of the terminal device 200A in the present embodiment will next be described with reference to FIG. 11. FIG. 11 is a flowchart of assistance in explaining an operation of the terminal device in the second embodiment.

When the worker starts an input of work information, the terminal device 200A in the present embodiment starts monitoring the key input by the input receiving unit 230 (S1101). The terminal device 200A next receives the key input by the input receiving unit 230 (S1102).

Next, the terminal device 200A determines by the input receiving unit 230 whether or not an enter key is depressed (S1103). When the enter key is depressed, the input receiving unit 230 in the present embodiment determines that the input of the work information is completed.

The terminal device 200A waits when the input of the work information is not completed in S1103.

When the input of the work information is completed in S1103, the terminal device 200A obtains the key input before the input of the enter key as the work information by the input receiving unit 230 (S1104). The terminal device 200A next generates a bar code from the input work information by the bar code generating unit 240 (S1105).

Next, the terminal device 200A determines whether or not to perform masking processing by the masking processing unit 260 (S1106). For example, when the input receiving unit 230 receives a notification indicating that the work information is changed, the terminal device 200A in the present embodiment determines that masking processing is to be performed.

When it is determined in S1106 that masking processing is not to be performed, the terminal device 200A displays the generated bar code by the display control unit 250 (S1107), and then ends the processing.

When it is determined in S1106 that masking processing is to be performed, the terminal device 200A refers to the character type conversion table 271 and performs masking processing by the masking processing unit 260 (S1108). For example, the masking processing unit 260 masks a part changed in the work information. The masking processing unit 260 in the present embodiment masks mainly device information included in the work information.

The terminal device 200A next generates a bar code from the work information after the masking processing by the bar code generating unit 240 (S1109). Next, the terminal device 200A displays the bar code indicating the work information after the masking processing as a second bar code by the display control unit 250 (S1110), and then ends the processing.

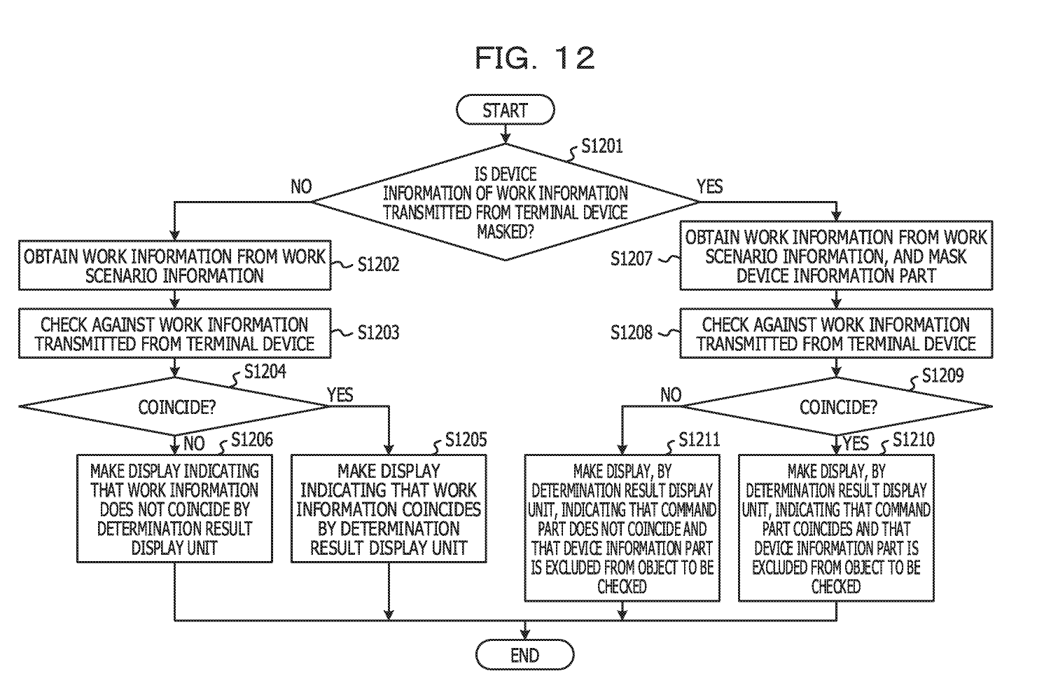

An operation of the management server 300A in the present embodiment will next be described with reference to FIG. 12. FIG. 12 is a flowchart of assistance in explaining an operation of the management server in the second embodiment. Referring to FIG. 12, description will be made mainly of operation of the masking presence or absence determining unit 370 and the work content determining unit 350A of the management server 300A.

The management server 300A in the present embodiment determines by the masking presence or absence determining unit 370 whether or not work information is masked (S1201). For example, the masking presence or absence determining unit 370 may determine whether or not the conversion character is included in the work information that the management server 300A has extracted from a bar code by the bar code reading unit 340. That is, when the extracted work information includes a character other than characters as an object for determination by the work content determining unit 350A, the masking presence or absence determining unit 370 may determine that the work information is work information after masking.

When it is determined in S1201 that the work information is not masked, the work content determining unit 350A obtains the work information of a work item ID corresponding to the extracted work information from the work scenario database 310 (S1202). The management server 300A next checks the work information transmitted from the terminal device 200A against the work information obtained in S1202 (S1203).

The work content determining unit 350A next determines whether or not the work information transmitted from the terminal device 200A and the work information obtained in S1202 coincide with each other (S1204).

When the work information transmitted from the terminal device 200A and the work information obtained in S1202 coincide with each other in S1204, the management server 300A makes display indicating that the work information transmitted from the terminal device 200A coincides on the imaging terminal 500 by the determination result display unit 360 (S1205). That is, the determination result display unit 360 displays information indicating that the work content is correct on the imaging terminal 500, and then ends the processing.

When the work information transmitted from the terminal device 200A and the work information obtained in S1202 do not coincide with each other in S1204, the management server 300A makes display indicating that the work information transmitted from the terminal device 200A does not coincide on the imaging terminal 500 by the determination result display unit 360 (S1206). That is, the determination result display unit 360 displays information indicating that the work content is incorrect on the imaging terminal 500, and then ends the processing.

When it is determined in S1201 that the work information is masked, the work content determining unit 350A obtains the work information of the work item ID corresponding to the extracted work information from the work scenario database 310. Then, the work content determining unit 350A refers to the character type conversion table 381, and masks device information, which is a numerical part of the obtained work information (S1207).

Next, the work content determining unit 350A checks the work information extracted from the bar code against the work information masked in S1207 (S1208). The work content determining unit 350A next determines whether or not the work information extracted from the bar code and the work information masked in S1207 coincide with each other (S1209).

When the work information masked in S1207 and the work information extracted from the bar code coincide with each other in S1209, the management server 300A displays a determination result on the imaging terminal 500 by the determination result display unit 360, the determination result indicating that the command of the extracted work information is correct and that the device information is excluded from an object of the determination. The management server 300A then ends the processing.

When the work information masked in S1207 and the work information extracted from the bar code do not coincide with each other in S1209, the management server 300A displays a determination result on the imaging terminal 500 by the determination result display unit 360, the determination result indicating that the command of the extracted work information is incorrect and that the device information is excluded from an object of the determination. The management server 300A then ends the processing.

As described above, in the present embodiment, when the device information included in the work information is changed immediately before work, only the changed part is excluded from an object of the correctness/incorrectness determination. Then, from the other work information, it is possible to determine whether the work content is correct or incorrect.

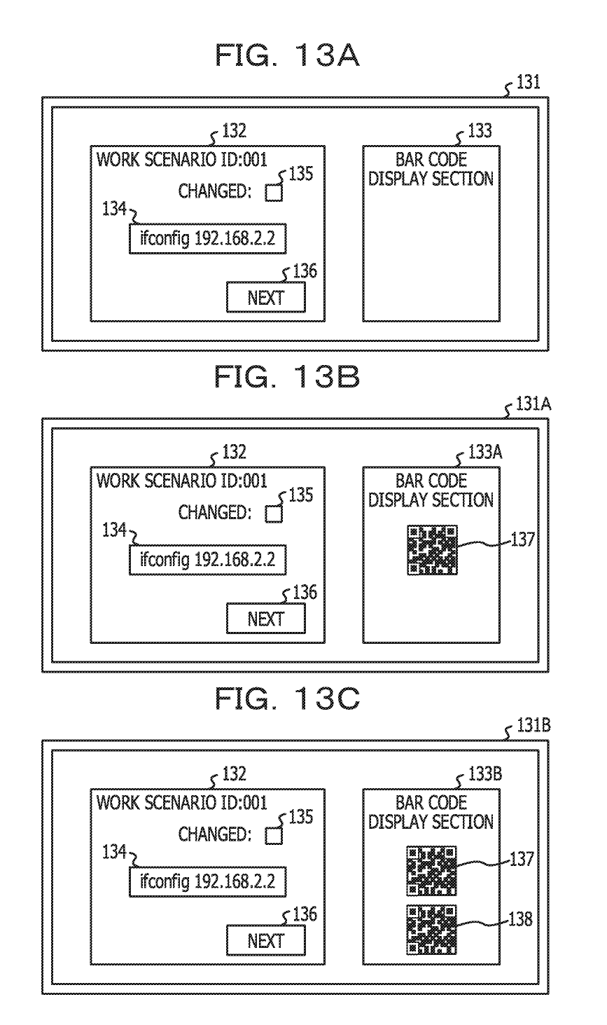

The processing of the masking processing unit 260, the masking presence or absence determining unit 370, and the work content determining unit 350A in the present embodiment will be concretely described in the following with reference to FIGS. 13A to 13C.

FIGS. 13A to 13C are diagrams illustrating an example of a work information input screen in the terminal device in the second embodiment. FIG. 13A illustrates an example of the input screen where work information is input. FIG. 13B illustrates an example of the input screen where a first bar code is displayed after the work information is input. FIG. 13C illustrates an example of the input screen where a second bar code is displayed after the work information is input.

Suppose that work information “ifconfig 192.168.2.2” in FIGS. 13A to 13C is changed from work information “ifconfig 192.168.1.1.”

Hence, in the work information included in the work scenario information read by the terminal device 200A and in the work scenario database 310, the work information “ifconfig 192.168.1.1,” rather than the work information “ifconfig 192.168.2.2,” remains as it is.

A screen 131 illustrated in FIG. 13A displays windows 132 and 133. The window 132 displays a work scenario ID, a work information input field 134, a check box 135 indicating whether the work information is changed or not, and a button 136 indicating completion of an input. The window 133 is a bar code display section in which a bar code is to be displayed.

As illustrated in FIG. 13A, the work information “ifconfig 192.168.2.2” is input to the input field 134. A check indicating that the work information is changed before work is input to the check box 135. The terminal device 200A in the present embodiment receives an operation of selecting the check box 135 as a notification indicating that the work information is changed.

When the check is input to the check box 135, the terminal device 200A generates a bar code 137 from the work information input to the input field 134, and displays the bar code 137 in a bar code display section 133A, as illustrated on a screen 131A in FIG. 13B.

At this time, the terminal device 200A masks the work information “ifconfig 192.168.2.2” by the masking processing unit 260. For example, the masking processing unit 260 refers to the character type conversion table 271, and converts, into the conversion character, device information as an object of conversion into the conversion character in the work information.

In the example of FIGS. 13A to 13C, “192.168.2.2,” which is a numerical part of the work information “ifconfig 192.168.2.2,” is the device information. The masking processing unit 260 therefore replaces the device information “192.168.2.2” with “X,” which is the conversion character. Hence, the work information after the masking is “ifconfig XXX.XXX.X.X.”

Next, the terminal device 200A generates a bar code from the work information after the masking, and displays the bar code.

A screen 131B in FIG. 13C displays a bar code 138 generated from the work information after the masking in a bar code display section 133B.

In the present embodiment, the display of the two bar codes 137 and 138 in the bar code display section 133B indicates that the input work information is masked.

In this case, the imaging terminal 500 images the bar code 138 after the masking, and distributes the bar code 138 after the masking to the management server 300A.

The management server 300A obtains the work information “ifconfig XXX.XXX.X.X” from an image of the bar code 138.

The management server 300A extracts the work item ID and the work scenario ID corresponding to the input work information from the image of the bar code 138. The management server 300A then obtains work information from the work scenario database 310. Here, the work information obtained by the management server 300A is the work information “ifconfig 192.168.1.1” before the change.

Accordingly, the management server 300A in the present embodiment refers to the character type conversion table 381 by the masking presence or absence determining unit 370. The management server 300A then masks the obtained work information “ifconfig 192.168.1.1.”

The masking in the management server 300A is similar to the masking in the terminal device 200A. In the present embodiment, the management server 300A and the terminal device 200A each include the same character type conversion table.

Hence, the work information “ifconfig 192.168.1.1” in the management server 300A becomes the work information “ifconfig XXX.XXX.X.X” after the masking.

By comparing the work information after the masking in the management server 300A with the work information obtained from the image of the bar code 138, the management server 300A can determine whether or not at least the command of the work information obtained from the image of the bar code 138 is correct.

In the present example, the command is “ifconfig.” The command of the work information obtained from the bar code 138 and the command of the work information obtained from the work scenario database 310 are thus found to coincide with each other.

As described above, according to the present embodiment, erroneous determination by the management server 300A is reduced by excluding the device information (parameter) included in the work information from an object to be checked by the management server 300A. The present embodiment can shorten work time because it may be not necessary to input a changed part to the management server before a start of work in order to reduce erroneous determination by the management server 300A. Further, the present embodiment can reduce the occurrence of a work error that may be involved in a change in the work information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A work support method executed by a work support system, the work support system including a terminal device, a managing device configured to manage the terminal device, and an information processing device including a camera, the work support method comprising:
receiving, by the terminal device, work information indicating a content of work executed;
generating identifying information based on the work information;
displaying an image of the generated identifying information;
capturing, by the information processing device, the image of the identifying information by the camera;
transmitting the captured image of the identifying information to the managing device;
obtaining, by the managing device, the work information from the captured image of the identifying information;
determining whether the obtained work information matches with work scenario information indicating a content of work executed by the terminal device; and
outputting a result of the determining.

2. The work support method according to claim 1, wherein
the terminal device is coupled to a network, and
the transmitting includes transmitting the captured image of the identifying information to the managing device while maintaining network security of the terminal device.

3. The work support method according to claim 2,
wherein the work scenario information includes coupling information indicating a content of coupling to a network apparatus coupled to the network.

4. The work support method according to claim 3,
wherein the work scenario information includes setting information indicating values of a plurality of parameters set in the network apparatus.

5. The work support method according to claim 1,
wherein the identifying information is a bar code.

6. The work support method according to claim 1,
wherein the identifying information is a moving image obtained by imaging a work state.

7. The work support method according to claim 1, further comprising:
executing, by the terminal device, masking processing by converting a part of the received work information into a given character when receiving a notification indicating that the received work information is changed from the work scenario information; and
generating the identifying information from the received work information resulting from the masking processing.

8. The work support method according to claim 1, further comprising:
determining, by the managing device, whether a part of the received work information has been converted into a given character based on the obtained work information;
generating converted work scenario information by converting a part of the work scenario information into the given character when determining that a part of the received work information has been converted into the given character; and
determining whether the converted work scenario information matches with the obtained work information.

9. A work support system, comprising:
a terminal device;
a managing device configured to manage the terminal device; and
an information processing device including a camera,
wherein the terminal device is configured to:
receive work information indicating a content of work executed,
generate identifying information based on the work information, and
display an image of the generated identifying information,
wherein the information processing device is configured to:
capture the image of the identifying information by the camera, and
transmit the captured image of the identifying information to the managing device, and
wherein the managing device is configured to:
obtain the work information from the captured image of the identifying information,
determine whether the obtained work information matches with work scenario information indicating a content of work executed by the terminal device, and
output a result of the determination.

10. The work support system according to claim 9, wherein
the terminal device is coupled to a network, and
the information processing device is configured to transmit the captured image of the identifying information to the managing device while maintaining network security of the terminal device.
